(19) United States
(12) Patent Application Publication
(10) Pub. No.: US 2024/0411887 A1
(43) Pub. Date: Dec. 12, 2024

(54) INSTALLATION CONTROL DEVICE, INSTALLATION CONTROL METHOD, SHARING SYSTEM, SHARING METHOD, AND STORAGE MEDIUM

(71) Applicant: NEC Corporation, Minato-ku, Tokyo (JP)

(72) Inventors: Kazuaki Nakajima, Tokyo (JP); Io Furuyama, Tokyo (JP); Kohei Tatara, Tokyo (JP)

(73) Assignee: NEC Corporation, Minato-ku, Tokyo (JP)

(21) Appl. No.: 18/698,864

(22) PCT Filed: Nov. 9, 2021
(86) PCT No.: PCT/JP2021/041076

§ 371 Date: Apr. 5, 2024

(51) Int. Cl. G06F 21/57

(52) U.S. Cl. CPC G06F 21/572; G06F 21/577; G06F 2221/033

(57) ABSTRACT

An installation control device according to an aspect of the present disclosure includes: at least one memory storing a set of instructions; and at least one processor configured to execute the set of instructions to: receive verification certification data including first authenticity information of target software and indicating that safety of the target software has been verified; compare the first authenticity information included in the verification certification data with second authenticity information of the target software; and perform control in such a way that the target software is installed when the first authenticity information is same as the second authenticity information.

### TECHNICAL FIELD

The present disclosure relates to a technique for controlling software installation.

### BACKGROUND ART

In general, to prevent the use of tampered software, data called authenticity certificates are used to prove that the software is genuine software. For example, the hash value of the software to be installed is compared with the hash value of the software included in the authenticity information of the software. Then, in a case where the hash value of the software to be installed matches the hash value of the software included in the authenticity information of the software, the software is installed. With such a mechanism, a risk that an unauthorized backdoor is set by tampering of software is reduced.

PTL 1 describes an information processing device that calculates a hash value that can uniquely identify a platform that provides an operation environment of an application, and compares the calculated hash value with a hash value of a platform for which reliability is secured. In a case where it is determined that both hash values do not match, the information processing device of PTL 1 restricts the use of the main device having the platform on which the hash value is produced.

PTLs 2 and 3 describe an information processing device that authenticates an update file using update software, a value uniquely calculated from the update software, and an electronic signature of the update software.

PTL 4 describes a game management device that determines consistency between an authentic game program that is stored in an authentic read-only memory and serves as a basis for verification by a third organization and a current game program stored in a current read-only memory.

### CITATION LIST

### Patent Literature

PTL 1: JP 2012-008641 A
PTL 2: JP 2012-150834 A
PTL 3: JP 2013-254506 A
PTL 4: JP 10-052549 A

### SUMMARY OF INVENTION

### Technical Problem

The techniques of PTLs 1 to 3 are techniques for determining whether software has been tampered with by comparing hash values. The technique of PTL 4 is a technique for determining whether software has been tampered with by comparing programs. In the techniques of PTLs 1 to 4, it is not possible to reduce a risk that a malicious manufacturer who produces software imparts vulnerability such as a backdoor to provided software.

An object of the present disclosure is to provide an installation control device and the like that can reduce not only the risk due to tampering with software, but also the risk due to vulnerability in software that has not been tampered with.

### Solution to Problem

An installation control device according to an aspect of the present disclosure includes: certification reception means for receiving verification certification data including first authenticity information of target software and indicating that safety of the target software has been verified; comparison means for compering the first authenticity information included in the verification certification data with second authenticity information of the target software; and control means for performing control in such a way that the target software is installed when the first authenticity information is same as the second authenticity information.

An installation control method according to an aspect of the present disclosure includes: receiving verification certification data including first authenticity information of target software and indicating that safety of the target software has been verified; comparing the first authenticity information included in the verification certification data with second authenticity information of the target software; and performing control in such a way that the target software is installed when the first authenticity information and the second authenticity information are same.

A storage medium according to an aspect of the present disclosure stores a program for causing a computer to execute: certification reception processing of receiving verification certification data including first authenticity information of target software and indicating that safety of the target software has been verified; comparison processing of comparing the first authenticity information included in the verification certification data with second authenticity information of the target software; and control processing of performing control in such a way that the target software is installed when the first authenticity information and the second authenticity information are same.

A sharing system according to an aspect of the present disclosure includes: certification reception means for receiving verification certification data including first authenticity information of target software and indicating that safety of the target software has been verified; and notification means for notifying an installation control device of the verification certification data, the installation control device being configured to: receive the verification certification data; compare the first authenticity information included in the verification certification data with second authenticity information of the target software; and perform control in such a way that the target software is installed when the first authenticity information and the second authenticity information are same.

A sharing method according to an aspect of the present disclosure includes: receiving verification certification data including first authenticity information of target software and indicating that safety of the target software has been verified; and notifying an installation control device of the verification certification data, the installation control device being configured to: receive for notifying an installation control device of the verification certification data, the installation control device being configured to: receive the verification certification data; compare the first authenticity information included in the verification certification data with second authenticity information of the target software; and perform control in such a way that the target software is installed when the first authenticity information and the second authenticity information are same.

A storage medium according to an aspect of the present disclosure store a program for causing a computer to execute: certification reception processing of receiving verification certification data including first authenticity information of target software and indicating that safety of the target software has been verified; and notification processing of notifying an installation control device of the verification certification data, the installation control device being configured to: receive the verification certification data; compare the first authenticity information included in the verification certification data with second authenticity information of the target software, and perform control in such a way that the target software is installed when the first authenticity information and the second authenticity information are same.

An aspect of the present disclosure is also achieved by a program stored in the above-described storage medium.

### Advantageous Effects of Invention

The present disclosure has an effect of reducing not only a risk due to tampering with software but also a risk due to vulnerability of software that has not been tampered with.

### BRIEF DESCRIPTION OF DRAWINGS

FIG. 1 is a block diagram illustrating an example of a configuration of an installation control device according to a first example embodiment of the present disclosure.

FIG. 2 is a flowchart illustrating an example of an operation of the installation control device according to the first example embodiment of the present disclosure.

FIG. 3 is a block diagram illustrating an example of a configuration of a sharing system according to a second example embodiment of the present disclosure.

FIG. 4 is a flowchart illustrating an example of an operation of the sharing system according to the second example embodiment of the present disclosure.

FIG. 5 is a block diagram illustrating an example of a configuration of a sharing system according to a third example embodiment of the present disclosure.

FIG. 6 is a flowchart illustrating an example of an operation of the sharing system according to the third example embodiment of the present disclosure.

FIG. 7 is a flowchart illustrating an example of an operation of the sharing system according to the third example embodiment of the present disclosure.

FIG. 8 is a block diagram illustrating an example of a configuration of information processing according to a fourth example embodiment of the present disclosure.

FIG. 9 is a flowchart illustrating an example of an operation of an information processing device according to the fourth example embodiment of the present disclosure.

FIG. 10 is a diagram illustrating an example of a hardware configuration of a computer that can implement a sharing system, an information processing device, and an installation control device according to an example embodiment of the present disclosure.

### EXAMPLE EMBODIMENT

Hereinafter, example embodiments of the present disclosure will be described in detail with reference to the drawings.

### First Example Embodiment

First, an installation control device according to a first example embodiment of the present disclosure will be described in detail with reference to the drawings.

### <Configuration>

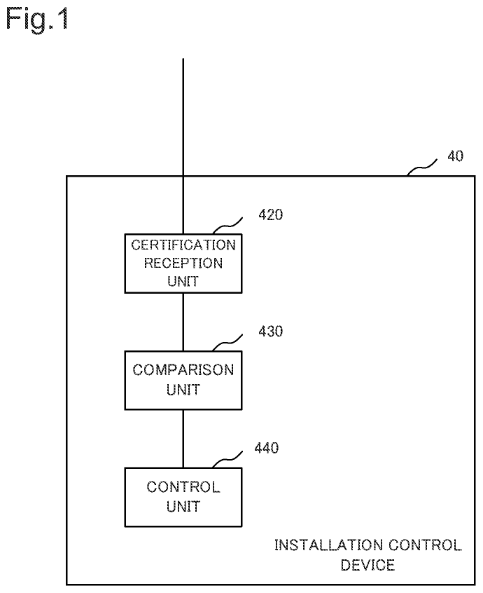

FIG. 1 is a block diagram illustrating an example of a configuration of an installation control device according to a first example embodiment of the present disclosure. In the example illustrated in FIG. 1, an installation control device 40 according to the present example embodiment includes a certification reception unit 420, a comparison unit 430, and a control unit 440. The certification reception unit 420 receives verification certification data that includes first authenticity information of target software and indicates that the safety of the target software has been verified. The comparison unit 430 compares the first authenticity information included in the verification certification data with second authenticity information of the target software. The control unit 440 controls the installation of the target software to be executed in a case where the first authenticity information and the second authenticity information are the same. In the present example embodiment, the target software and the second authenticity information of the target software are acquired in advance.

### <Certification Reception Unit 420>

The certification reception unit 420 receives the verification certification data of the target software from, for example, a sharing system or the like to be described later. The certification reception unit 420 may transmit a request for the verification certification data of the target software to the sharing system or the like, and receive the verification certification data of the target software transmitted from the sharing system or the like in response to the transmitted request. In this case, the request transmitted by the certification reception unit 420 may include identification information that uniquely identifies the target software. The sharing system or the like may hold the verification certification data of the target software associated with the identification information of the target software.

The target software is software that is about to be installed. The authenticity information (each of the first authenticity information and the second authenticity information) of the target software is data proving that the target software has authenticity, that is, the target software is provided by a provider of the target software and has not been tampered with. The authenticity information of the target software may be, for example, data generated by encrypting data including a hash value of a file of the target software using a private key of a provider of the target software.

The verification certification data is data proving that the verification certification data is generated by a verification organization, that the target software on which the verification has been performed has authenticity, and a verification result of the target software performed by the verification organization. The verification certification data is, for example, data generated by encrypting data including authenticity information (that is, the first authenticity information described above) of the target software provided to the verification organization and a verification result using a private key of the verification organization.

The verification may include, for example, a vulnerability verification and a backdoor verification. The verification result may include, for example, a combination of information indicating the performed verification and information indicating the result of the performed verification. Specifically, the verification result may include, for example, a combination of information indicating the performed vulnerability verification and vulnerability information detected by the vulnerability verification. The verification result may include a combination of information indicating the type of backdoor verification and the detected backdoor information. The detected vulnerability information may include, for example, a combination of a severity indicating a degree of severity of the detected vulnerability and information indicating contents of the detected vulnerability. When no vulnerability has been detected, the detected vulnerability information may be predetermined information indicating that no vulnerability has been detected. The detected backdoor information may include information indicating the type of the detected backdoor. When a backdoor has not been detected by the backdoor verification, the detected backdoor information may be information indicating that the backdoor has not been detected.

The fact that the safety of the target software has been verified may be represented, for example, by the verification certification data indicating that the vulnerability of a severity that is more severe than a predetermined severity is not detected and a backdoor has not been detected.

### <Comparison Unit 430>

The comparison unit 430 compares first authenticity information, which is authenticity information of the target software, included in the verification certification data with second authenticity information, which is authenticity information obtained in advance, of the target software. The second authenticity information indicates authenticity information provided together with the target software being installed. For example, the comparison unit 430 acquires a public key of the verification organization, and decrypts the verification certification data using the acquired public key. The comparison unit 430 extracts the first authenticity information encrypted by the private key of the manufacturer of the target software from the decrypted verification certification data. The comparison unit 430 may acquire the public key of the manufacturer of the target software, and decrypt the extracted first authenticity information encrypted with the private key of the manufacturer of the target software with the acquired public key of the manufacturer of the target software. Furthermore, the comparison unit 430 may decrypt the second authenticity information encrypted with the private key of the manufacturer of the target software with the acquired public key of the manufacturer of the target software. Then, the comparison unit 430 may compare the decrypted first authenticity information with the decrypted second authenticity information.

### <Control Unit 440>

In a case where the first authenticity information and the second authenticity information are the same as a result of comparison, the control unit 440 performs control such that the target software is installed. For example, the control unit 440 may permit activation of an installer of the target software. In a case where the first authenticity information and the second authenticity information are not the same, the control unit 440 performs control such that the target software is not installed. For example, the control unit 440 may prohibit the activation of the installer of the target software.

In a case where the verification result included in the verification certification data indicates that the target software is not safe, the control unit 440 may perform control such that the target software is not installed. For example, in a case where the verification result indicates that the detected vulnerability includes a vulnerability with a severity equal to or higher than a predetermined severity, the control unit 440 may determine that the target software is not safe. For example, in a case where the verification result indicates that a backdoor has been detected, the control unit 440 may determine that the target software is not safe.

In a case where the verification certification data of the target software cannot be obtained, the control unit 440 may perform control such that the target software is not installed. For example, in a case where there is a response indicating that the verification certification data of the target software does not exist from the above-described sharing system or the like to the request for the verification certification data of the target software, the control unit 440 may determine that the verification certification data of the target software has not been obtained. For example, in a case where the requested verification certification data is not transmitted from the above-described sharing system or the like within a predetermined time after the request for the verification certification data of the target software is transmitted, the control unit 440 may determine that the verification certification data of the target software has not been obtained.

For example, the control unit 440 may permit installation of the target software by transmitting information permitting installation of the target software to the information processing device to be installed. For example, the control unit 440 may prohibit the installation of the target software by transmitting information prohibiting the installation of the target software to the information processing device to be installed.

### <Operation>

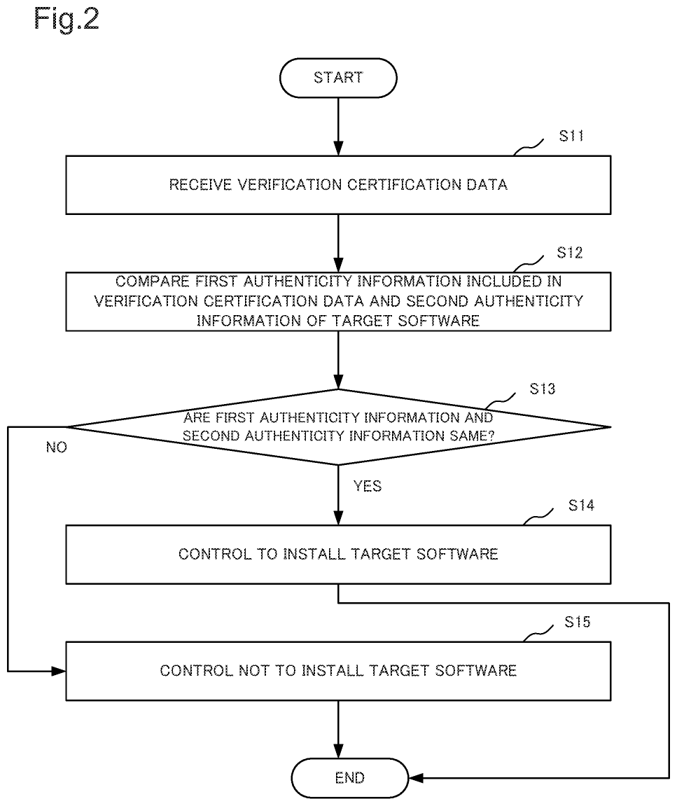

FIG. 2 is a flowchart illustrating an example of an operation of the installation control device according to the first example embodiment of the present disclosure. At the time when the operation illustrated in FIG. 2 is started, the second authenticity information of the target software is obtained. In the example illustrated in FIG. 2, first, the certification reception unit 420 receives the verification certification data of the target software from the sharing system or the like (step S21). Next, the comparison unit 430 compares the first authenticity information included in the verification certification data with the second authenticity information of the target software (step S22). In a case where the first authenticity information and the second authenticity information are the same (YES in step S23), the control unit 440 performs control such that the target software is installed (step S24). In a case where the first authenticity information and the second authenticity information are not the same (NO in step S23), the control unit 440 performs control such that the target software is not installed (step S25).

### <Effects>

The present example embodiment has an effect of reducing not only a risk due to tampering with software but also a risk due to vulnerability of software that has not been tampered with. The reason is that the certification reception unit 420 receives, as a result of verification, the verification certification data of the target software indicating that the target software is safe and the verification is performed on the target software having authenticity. The verification certification data indicates the verification result that the untampered target software is not vulnerable. The backdoor can also be regarded as a type of vulnerability. Then, this is because the control unit 440 controls the target software to be installed in a case where the first authenticity information included in the verification certification data is the same as the second authenticity information of the target software. If the first authenticity information and the second authenticity information are the same, the target software to be installed is the same as the target software indicated to be safe by the verification certification data. In this case, it can be considered that the target software to be installed is not tampered with.

### Second Example Embodiment

### <Configuration>

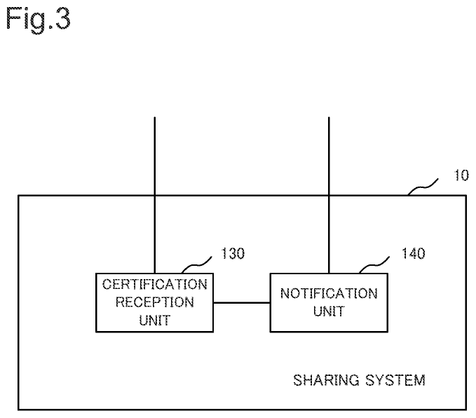

FIG. 3 is a block diagram illustrating an example of a configuration of a sharing system according to a second example embodiment of the present disclosure. In the example illustrated in FIG. 3, a sharing system 10 according to the second example embodiment of the present disclosure includes a certification reception unit 130 and a notification unit 140.

### <Certification Reception Unit 130>

The certification reception unit 130 receives verification certification data that includes first authenticity information of target software and indicates that the safety of the target software has been verified.

The target software of the present example embodiment is the same as the target software of the first example embodiment. The verification certification data of the present example embodiment is the same as the verification certification data of the first example embodiment. The authenticity information (that is, the first authenticity information and the second authenticity information) of the present example embodiment is the same as the authenticity information of the present example embodiment. That is, the first authenticity information and the second authenticity information of the present example embodiment are the same as the first authenticity information and the second authenticity information of the first example embodiment.

The certification reception unit 130 may acquire the verification certification data from the verification device that verifies the target software and generates the verification certification data proving the verification result. The verification device may be an information processing device or the like managed by a verification organization that performs verification.

### <Notification Unit 140>

The notification unit 140 notifies the installation control device of the verification certification data. The installation control device receives the verification certification data. The installation control device compares the first authenticity information included in the verification certification data with the second authenticity information of the target software. The installation control device performs control such that the installation of the target software is executed in a case where the first authenticity information and the second authenticity information are the same.

The installation control device of the present example embodiment may be the installation control device 40 of the first example embodiment. The installation control device of the present example embodiment may be an installation control device 400 according to the example embodiment described later.

### <Operation>

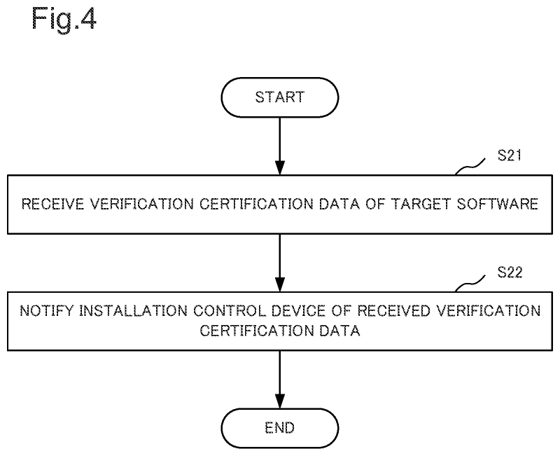

FIG. 4 is a flowchart illustrating an example of an operation of the sharing system according to the second example embodiment of the present disclosure. In the example illustrated in FIG. 4, the certification reception unit 130 receives, for example, the verification certification data of the target software from the verification device that generates the verification certification data (step S21). Then, the notification unit 140 notifies the installation control device of the received verification certification data (step S22).

### <Effects>

The present example embodiment has the same effect as that of the first example embodiment. This is because the notification unit 140 notifies the installation control device of the verification certification data. Then, this is because the installation control device receives the verification certification data of the target software indicating that the target software is safe as a result of the verification and the verification is performed on the target software having authenticity. The verification certification data indicates the verification result that the untampered target software is not vulnerable. The backdoor can also be regarded as a type of vulnerability. Furthermore, this is because the installation control device performs control such that the target software is installed in a case where the first authenticity information included in the verification certification data is the same as the second authenticity information of the target software. If the first authenticity information and the second authenticity information are the same, the target software to be installed is the same as the target software indicated to be safe by the verification certification data. In this case, it can be considered that the target software to be installed is not tampered with.

### Third Example Embodiment

### <Configuration>

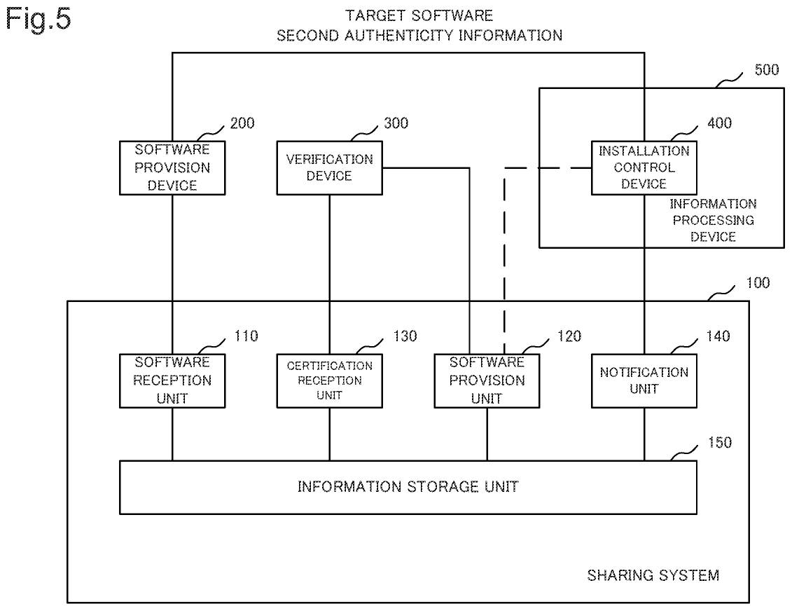

FIG. 5 is a block diagram illustrating an example of a configuration of a sharing system according to a third example embodiment of the present disclosure. In the example illustrated in FIG. 5, a sharing system 100 of the present example embodiment includes a software reception unit 110, a software provision unit 120, a certification reception unit 130, a notification unit 140, and an information storage unit 150. The sharing system 100 is communicably connected to each information processing device 500 including a software provision device 200, a verification device 300, an installation control device 400, and an installation control device 400. The certification reception unit 130 and the notification unit 140 according to the present example embodiment have functions similar to the functions of the certification reception unit 130 and the notification unit 140 according to the second example embodiment. The certification reception unit 130 and the notification unit 140 according to the present example embodiment operate similarly to the operation of the certification reception unit 130 and the operation of the notification unit 140 according to the second example embodiment.

### <Software Provision Device 200>

The software provision device 200 provides the target software and the authenticity information of the target software to the software reception unit 110 of the sharing system 100. The software provision device 200 is an information processing device managed by a provider of the target software. The provided target software is data necessary for installing the target software. The target software may be provided, for example, in the form of one file. The authenticity information of the target software is data proving that the target software is provided by a provider of the target software and has not been tampered with. The authenticity information of the target software may be, for example, data generated by encrypting a hash value of a file of the target software using a private key of a provider of the target software. The software provision device 200 may generate identification information for uniquely identifying the target software, and associate the generated identification information with the target software and the authenticity information of the target software. The software provision device 200 may provide the target software and the authenticity information of the target software associated with the identification information to the software reception unit 110 of the sharing system 100 together with the identification information. The identification information of the target software may be included in the data of the target software.

As described later, the target software and the authenticity information of the target software provided from the software provision device 200 to the software reception unit 110 are provided to the verification device 300 by the software provision unit 120. In the description of the example embodiment of the present disclosure, the authenticity information provided to the verification device 300 is described as first authenticity information.

The software provision device 200 provides the target software, the authenticity information of the target software, and the identification information to the information processing device 500 via a medium such as a communication network or a storage medium, for example. In the description of the example embodiment of the present disclosure, the authenticity information provided from the software provision device 200 to the information processing device 500 together with the target software is described as second authenticity information.

### <Verification Device 300>

The verification device 300 receives the target software and the authenticity information of the target software from the software provision unit 120 of the sharing system 100. The verification device 300 is, for example, a device that performs the above-described verification. The verification device 300 is, for example, an information processing device managed by a verification organization (in the following description, simply referred to as a verification organization) that performs verification. The verification device 300 confirms the authenticity of the target software using the received authenticity information. In other words, the verification device 300 uses the received authenticity information to confirm that the target software received from the software provision unit 120 is provided from the provider of the target software and has not been tampered with. In a case where the authenticity information is data generated by encrypting the hash value of a file of the target software using the private key of the provider of the target software, the verification device 300 acquires the public key of the provider of the target software. Then, the verification device 300 confirms the authenticity of the target software using the received authenticity information and the acquired public key of the provider of the target software. The method of acquiring the public key of the provider of the target software and the method of confirming the authenticity of the target software using the received authenticity information and the acquired public key of the provider of the target software may be existing methods. In a case where the authenticity of the target software is not confirmed, the verification device 300 does not need to verify the target software.

Then, the verification device 300 verifies the target software. Specifically, the verification device 300 performs a verification such as a vulnerability verification of target software and a backdoor verification. The verification device 300 generates the above-described verification certification data representing the verification result.

The verification device 300 transmits the generated verification certification data to the certification reception unit 130 of the sharing system 100.

### <Information Processing Device 500>

The information processing device 500 includes an installation control device 400 described later. The information processing device 500 acquires the target software and the second authenticity information of the target software from the software provision device 200 via a medium such as a communication network or a storage medium as described above. The information processing device 500 provides the acquired second authenticity information to the installation control device 400 before installing the acquired target software.

The information processing device 500 is notified (in other words, receives) of the first authenticity information of the target software from the notification unit 140 of the sharing system 100. The installation control device 400 may request the authenticity information of the target software from the sharing system 100 via the information processing device 500. Then, the installation control device 400 may receive the authenticity information of the target software as the first authenticity information from the sharing system 100 via the information processing device 500. At that time, the information processing device 500 receives the first authenticity information from the sharing system 100, and provides the received first authenticity information to the installation control device 400.

Then, the information processing device 500 installs the target software under the control of the installation control device 400. Specifically, in a case where information permitting installation is output from the installation control device 400, the information processing device 500 installs the target software. The information processing device 500 does not install the target software when the information prohibiting the installation is output from the installation control device 400.

### <Installation Control Device 400>

The installation control device 400 receives the second authenticity information provided from the software provision device 200 to the information processing device 500. The installation control device 400 further receives the first authenticity information notified from the notification unit 140.

The installation control device 400 compares the first authenticity information included in the verification certification data with the second authenticity information of the target software. The installation control device 400 controls the installation of the target software to be executed in a case where the first authenticity information and the second authenticity information are the same.

The information processing device 500 may transmit a request for the verification certification data of the target software to the sharing system 100 before activating the installer of the target software. The request for the verification certification data of the target software may include the identification information of the target software. The notification unit 140 of the sharing system 100 receives the request for the verification certification data of the target software. The notification unit 140 identifies the requested verification certification data using the identification information of the target software included in the request. Then, the notification unit 140 transmits the identified verification certification data to the information processing device 500. The information processing device 500 receives the verification certification data of the target software from the notification unit 140 of the sharing system 100, and provides the received verification certification data to the installation control device 400.

The information processing device 500 is implemented as, for example, a computer (for example, a personal computer, a portable terminal device such as a smartphone, or the like, or another computer or the like) including a memory and a processor that executes a program loaded in the memory. The installation control device 400 is achieved by a memory of the information processing device 500 and a processor of the information processing device 500 that executes a program that is loaded into the memory of the information processing device 500 and controls execution of an installer of the target software.

The installation control device 400 and the information processing device 500 will be described in detail later as a fourth example embodiment.

### <Sharing System 100>

### <Software Reception Unit 110>

The software reception unit 110 receives the target software and the authenticity information of the target software from the software provision device 200. The software reception unit 110 stores the target software and the authenticity information of the target software from the software provision device 200 in the information storage unit 150. More specifically, the software reception unit 110 receives the target software, the authenticity information of the target software, and the identification information of the target software from the software provision device 200. The identification information of the target software is associated with the target software and authenticity information of the target software. The software reception unit 110 stores the target software, the authenticity information of the target software, and the identification information of the target software from the software provision device 200 in the information storage unit 150.

### <Software Provision Unit 120>

The software provision unit 120 provides (in other words, transmit) the target software and the authenticity information of the target software stored in the information storage unit 150 to the verification device 300. As described above, the authenticity information provided by the software provision device 200 to the verification device 300 is described as the first authenticity information. The software provision unit 120 may provide the target software and the authenticity information of the target software together with the identification information of the target software to the verification device 300.

The software provision unit 120 may further provide the target software and the authenticity information of the target software stored in the information storage unit 150 to the information processing device 500. As described above, the authenticity information provided to the information processing device 500 together with the target software is described as the second authenticity information. The authenticity information provided to the information processing device 500 by the software provision unit 120 corresponds to the second authenticity information.

### <Certification Reception Unit 130>

The certification reception unit 130 receives the above-described verification certification data from the verification device 300. The certification reception unit 130 stores the received verification certification data in the information storage unit 150. Specifically, the certification reception unit 130 receives, from the verification device 300, the verification certification data of the target software associated with the identification information of the target software. The certification reception unit 130 stores the verification certification data of the target software associated with the identification information of the target software in the information storage unit 150.

### <Notification Unit 140>

The notification unit 140 reads the verification certification data of the target software from the information storage unit 150, and notifies the information processing device 500 of the read verification certification data (that is, transmits). The information processing device 500 receives the verification certification data and provides the received verification certification data to the installation control device 400. In other words, the notification unit 140 reads the verification certification data of the target software from the information storage unit 150, and notifies the installation control device 400 of the read verification certification data (that is, transmit).

As described above, the installation control device 400 may request the verification certification data of the target software to be installed from the sharing system 100 (specifically, the notification unit 140) by the information processing device 500. In other words, the information processing device 500 may receive the request for the verification certification data of the target software to be installed output by the installation control device 400. The information processing device 500 may transmit the request for the verification certification data of the target software to be installed received from the installation control device 400 to the sharing system 100 (specifically, the notification unit 140). The request for the verification certification data of the target software may include the identification information of the target software. The notification unit 140 uses the identification information of the target software included in the request to read the requested verification certification data from the information storage unit 150 from the verification certification data stored in the information storage unit 150. Specifically, the notification unit 140 reads, from the information storage unit 150, the verification certification data associated with the identification information of the target software included in the request. The notification unit 140 transmits the read verification certification data, that is, the requested verification certification data to the information processing device 500 (specifically, the installation control device 400 included in the information processing device 500).

The information processing device 500 receives the verification certification data notified (that is, transmitted) from the notification unit 140, and provides the received verification certification data to the installation control device 400. The installation control device 400 receives the verification certification data. When receiving the verification certification data, the installation control device 400 operates as described above. The installation control device 400 may operate similarly to the installation control device 40 of the first example embodiment when receiving the verification certification data. When receiving the verification certification data, the installation control device 400 may operate similarly to the installation control device of the second example embodiment. When receiving the verification certification data, the installation control device 400 may operate similarly to the installation control device 400 of the fourth example embodiment described later.

### <Operation>

Next, an operation of the sharing system 100 according to the third example embodiment of the present disclosure will be described in detail with reference to the drawings.

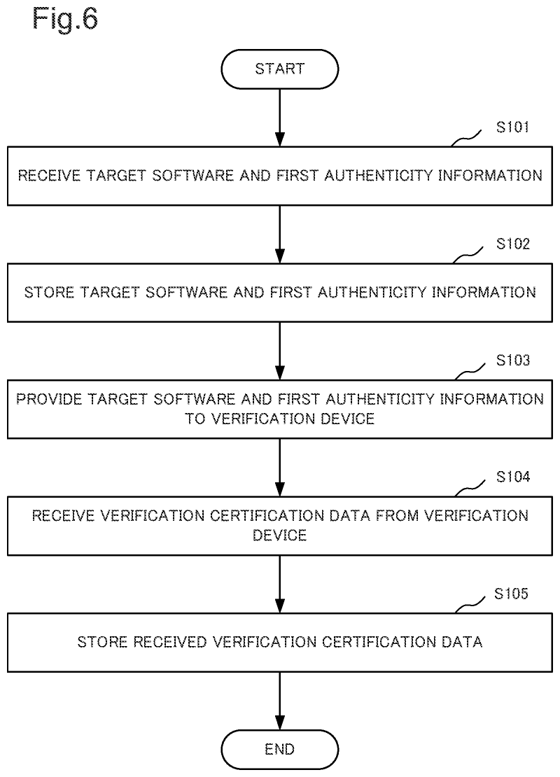

FIG. 6 is a flowchart illustrating an example of an operation of the sharing system according to the third example embodiment of the present disclosure. FIG. 6 illustrates an example of an operation in which the sharing system 100 according to the present example embodiment receives the target software and the verification certification data. In the example illustrated in FIG. 6, in step S101, the software reception unit 110 receives the target software and the authenticity information from the software provision device 200. In the example of FIG. 6, since the authenticity information received in step S101 is provided to the verification device 300, the authenticity information received in step S101 corresponds to the first authenticity information. In other words, the software reception unit 110 receives the target software and the first authenticity information from the software provision device 200 (step S101). The software reception unit 110 stores the received target software and first authenticity information in the information storage unit 150. In other words, the information storage unit 150 stores the target software and the first authenticity information (step S102).

Next, the software provision unit 120 provides the target software and the first authenticity information to the verification device 300 (step S103). The verification device 300 verifies the received target software. The verification device 300 generates the verification certification data including the verification result and the first authenticity information. The verification device 300 transmits the generated verification certification data to the certification reception unit 130 of the sharing system 100. The certification reception unit 130 receives the verification certification data from the verification device 300 (step S104). The certification reception unit 130 stores the received verification certification data in the information storage unit 150. The information storage unit 150 stores the verification certification data received by the certification reception unit 130 (step S105).

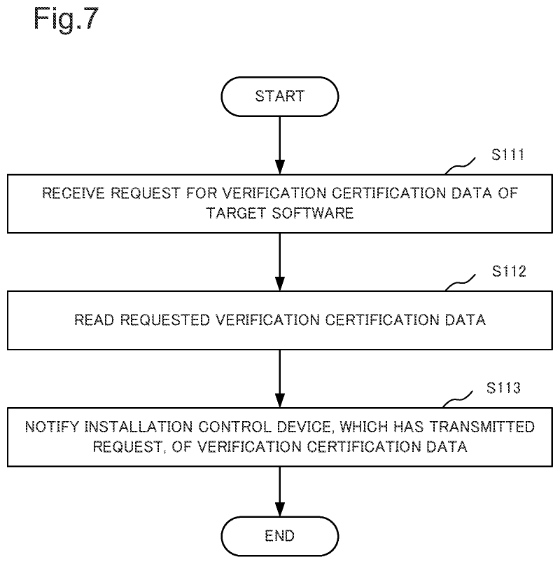

FIG. 7 is a flowchart illustrating an example of an operation of the sharing system according to the third example embodiment of the present disclosure. FIG. 7 illustrates an example of an operation in which the sharing system 100 according to the present example embodiment notifies the verification certification data. In the example illustrated in FIG. 7, the notification unit 140 receives a request for the verification certification data of the target software from the installation control device 400 (step S111). The notification unit 140 reads the requested verification certification data from the information storage unit 150 (step S112). The notification unit 140 notifies the installation control device 400 that has transmitted the request of the read verification certification data, that is, the requested verification certification data (step S113).

### <Effects>

The present example embodiment described above has the same effect as the effect of the second example embodiment. The reason is the same as the reason why the effect of the second example embodiment occurs.

### Fourth Example Embodiment

Next, a fourth example embodiment of the present disclosure will be described in detail with reference to the drawings. The information processing device 500 according to the present example embodiment is relevant to the information processing device 500 of the third example embodiment. The information processing device 500 according to the present example embodiment represents a specific example of the information processing device 500 according to the third example embodiment. The installation control device 400 included in the information processing device 500 according to the present example embodiment is relevant to the installation control device 400 of the third example embodiment. The installation control device 400 included in the information processing device 500 according to the present example embodiment represents a specific example of the installation control device 400 of the third example embodiment.

### <Configuration>

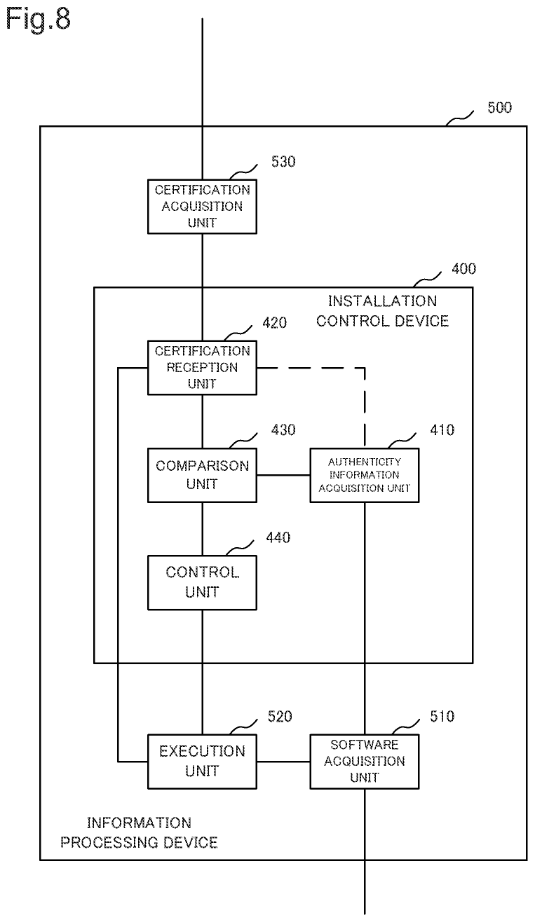

FIG. 8 is a block diagram illustrating an example of a configuration of information processing according to the fourth example embodiment of the present disclosure. In the example illustrated in FIG. 8, the information processing device 500 includes an installation control device 400, a software acquisition unit 510, an execution unit 520, and a certification acquisition unit 530. The installation control device 400 includes an authenticity information acquisition unit 410, a certification reception unit 420, a comparison unit 430, and a control unit 440. The certification reception unit 420, the comparison unit 430, and the control unit 440 of the present example embodiment have functions similar to the functions of the certification reception unit 420, the comparison unit 430, and the control unit 440 of the first example embodiment. The certification reception unit 420, the comparison unit 430, and the control unit 440 of the present example embodiment perform the same operations as the operations of the certification reception unit 420, the comparison unit 430, and the control unit 440 of the first example embodiment.

### <Software Acquisition Unit 510>

The software acquisition unit 510 acquires the target software and the authenticity information of the target software from the software provision device 200 via, for example, a communication network or a storage medium. The authenticity information acquired by the software acquisition unit 510 is the above-described second authenticity information.

The software acquisition unit 510 sends the acquired target software to the execution unit 520. The software acquisition unit 510 sends the acquired second authenticity information to the installation control device 400 (specifically, the authenticity information acquisition unit 410 of the installation control device 400).

### <Execution Unit 520>

The execution unit 520 receives the target software from the software acquisition unit 510.

When installation of the target software is instructed by the user of the information processing device 500, the execution unit 520 executes installation of the target software under the control of the installation control device 400 (specifically, the control unit 440 of the installation control device 400). The instruction to install the target software by the user of the information processing device 500 may be performed using an input device such as a touch panel, a keyboard, and a mouse of the information processing device 500.

Specifically, when installation of the target software is instructed by the user of the information processing device 500, the execution unit 520 inquires, for example, the installation control device 400 (specifically, for example, the certification reception unit 420) about whether the target software can be installed. In other words, the execution unit 520 transmits a request for information indicating whether to install the target software to the installation control device 400 (specifically, for example, the certification reception unit 420). The execution unit 520 receives, from the control unit 440 of the installation control device 400, information for permitting installation or information for prohibiting installation in response to a request for information indicating whether the target software can be installed. When information permitting installation is output from the installation control device 400, the execution unit 520 executes installation of the target software. The execution unit 520 does not execute the installation of the target software when the information for prohibiting the installation is output from the installation control device 400.

### <Certification Acquisition Unit 530>

The certification acquisition unit 530 receives the verification certification data of the target software from the sharing system 100 (specifically, the notification unit 140 of the sharing system 100).

Specifically, for example, the certification acquisition unit 530 receives a request for the verification certification data of the target software from the certification reception unit 420 of the installation control device 400. Upon receiving the request for the verification certification data of the target software from the certification reception unit 420, the certification acquisition unit 530 transmits the request for the verification certification data of the target software to the notification unit 140 of the sharing system 100. The certification acquisition unit 530 receives the verification certification data of the target software from the notification unit 140 of the sharing system 100. The certification acquisition unit 530 sends the verification certification data of the target software received from the notification unit 140 of the sharing system 100 to the certification reception unit 420 of the installation control device 400.

### <Authenticity Information Acquisition Unit 410>

The authenticity information acquisition unit 410 receives the second authenticity information of the target software from the software acquisition unit 510. Upon receiving the second authenticity information of the target software from the software acquisition unit 510, the authenticity information acquisition unit 410 may send information indicating that the second authenticity information has been received to the certification reception unit 420. The authenticity information acquisition unit 410 sends the second authenticity information of the target software received from the software acquisition unit 510 to the comparison unit 430.

### <Certification Reception Unit 420>

The certification reception unit 420 receives a request for information indicating whether the target software can be installed from the execution unit 520. Upon receiving the request for information indicating whether the target software can be installed from the execution unit 520, the certification reception unit 420 transmits a request for the verification certification data of the target software to the notification unit 140 of the sharing system 100 via the certification acquisition unit 530. Specifically, the certification reception unit 420 sends a request for the verification certification data of the target software to the certification acquisition unit 530. The certification acquisition unit 530 receives a request for the verification certification data of the target software from the certification reception unit 420. Upon receiving the request for the verification certification data of the target software from the certification reception unit 420, the certification acquisition unit 530 transmits the received request for the verification certification data of the target software to the notification unit 140 of the sharing system 100.

In response to the request for the verification certification data of the target software, the certification reception unit 420 receives the verification certification data transmitted from the notification unit 140 of the sharing system 100 via the certification acquisition unit 530. Specifically, the certification acquisition unit 530 receives the verification certification data of the target software from the notification unit 140 of the sharing system 100. Then, the certification reception unit 420 receives the verification certification data of the target software from the certification acquisition unit 530.

The certification reception unit 420 sends the received verification certification data of the target software to the comparison unit 430. For example, in a case where the verification certification data of the target software has not been received within a predetermined time after the request for the verification certification data of the target software is transmitted, the certification reception unit 420 may send information indicating that the verification certification data does not exist to the comparison unit 430. For example, when receiving the information indicating that the verification certification data of the target software does not exist from the notification unit 140 of the sharing system 10, the certification reception unit 420 may send the information indicating that the verification certification data does not exist to the comparison unit 430.

### <Comparison Unit 430>

The comparison unit 430 receives the verification certification data of the target software from the certification reception unit 420. As described above, the verification certification data of the target software includes the first authenticity information of the target software. The comparison unit 430 receives the second authenticity information of the target software from the authenticity information acquisition unit 410.

The comparison unit 430 compares the first authenticity information of the target software included in the verification certification data of the target software with the received second authenticity information of the target software.

At that time, for example, the comparison unit 430 acquires a public key of the verification organization, and decrypts the verification certification data using the acquired public key. The comparison unit 430 extracts the first authenticity information encrypted by the private key of the manufacturer of the target software from the decrypted verification certification data. The comparison unit 430 may acquire the public key of the manufacturer of the target software, and decrypt the extracted first authenticity information encrypted with the private key of the manufacturer of the target software with the acquired public key of the manufacturer of the target software. Furthermore, the comparison unit 430 may decrypt the second authenticity information encrypted with the private key of the manufacturer of the target software with the acquired public key of the manufacturer of the target software. Then, the comparison unit 430 may compare the decrypted first authenticity information with the decrypted second authenticity information.

The public key of the manufacturer of the target software and the public key of the verification organization may be stored in advance, for example, in the information storage unit 150 of the sharing system 100. For example, the comparison unit 430 may acquire the public key of the manufacturer of the target software and the public key of the verification organization from the notification unit 140 of the sharing system 100 via a certification acquisition unit 320 and the certification acquisition unit 530.

For example, the comparison unit 430 may be configured to acquire the public key of the verification organization from the information storage unit 150 of the sharing system 100. The private key of the verification organization designated by the administrator of the sharing system 100 may be stored in advance in the information storage unit 150 of the sharing system 100. The private key of the verification organization other than the verification organization designated by the administrator of the sharing system 100 may not be stored in the information storage unit 150 of the sharing system 100. As a result, the verification organization that can issue the verification certification data can be limited to only the verification organization designated by the administrator of the sharing system 100. In this case, the sharing system 100 proves the correctness of the verification organization.

The comparison unit 430 notifies the control unit 440 of the result of comparison (that is, information indicating that the first authenticity information and the second authenticity information are the same, or information indicating that the first authenticity information and the second authenticity information are different). The comparison unit 430 may further send, to the control unit 440, information indicating a verification result included in the verification certification data.

When receiving the information indicating that the verification certification data of the target software does not exist from the certification reception unit 420, the comparison unit 430 may transmit the information indicating that the verification certification data of the target software does not exist to the control unit 440. When the verification certification data cannot be decrypted using the private key of the verification organization, the comparison unit 430 may send information indicating that the verification certification data is invalid to the control unit 440. In a case where the first authenticity information included in the verification certification data cannot be decrypted using the public key of the manufacturer of the target software, the comparison unit 430 may send information indicating that the verification certification data is invalid to the control unit 440. In a case where the second authenticity information cannot be decrypted using the public key of the manufacturer of the target software, the comparison unit 430 may send information indicating that the authenticity information is invalid to the control unit 440.

### <Control Unit 440>

the control unit 440 receives the result of comparison (that is, information indicating that the first authenticity information and the second authenticity information are the same, or information indicating that the first authenticity information and the second authenticity information are different) from the comparison unit 430. The control unit 440 may further receive information indicating a result of the verification from the comparison unit 430.

In a case where the result of comparison indicates that the first authenticity information and the second authenticity information are the same, the control unit 440 performs control such that the target software is installed. For example, the control unit 440 may permit activation of an installer of the target software. In a case where the result of comparison indicates that the first authenticity information and the second authenticity information are not the same, the control unit 440 performs control such that the target software is not installed. For example, the control unit 440 may prohibit the activation of the installer of the target software.

In a case where the verification result included in the verification certification data indicates that the target software is not safe, the control unit 440 may perform control such that the target software is not installed. For example, in a case where the verification result indicates that the detected vulnerability includes a vulnerability with a severity equal to or higher than a predetermined severity, the control unit 440 may determine that the target software is not safe. For example, in a case where the verification result indicates that a backdoor has been detected, the control unit 440 may determine that the target software is not safe.

The control unit 440 may receive information indicating that the verification certification data of the target software does not exist from the comparison unit 430. In a case where the information indicating that the verification certification data of the target software does not exist is received, that is, in a case where the verification certification data of the target software cannot be obtained, the control unit 440 may perform control such that the target software is not installed.

The control unit 440 may receive information indicating that the verification certification data is invalid from the comparison unit 430. In a case where information indicating that the verification certification data is invalid is received, the control unit 440 may perform control such that the target software is not installed.

The control unit 440 may receive information indicating that the authenticity information is invalid from the comparison unit 430. In a case where the information indicating that the authenticity information is invalid is received, the control unit 440 may perform control such that the target software is not installed.

For example, the control unit 440 may permit installation of the target software by transmitting information permitting installation of the target software to the information processing device to be installed. For example, the control unit 440 may prohibit the installation of the target software by transmitting information prohibiting the installation of the target software to the information processing device to be installed.

### <Operation>

Next, an operation of the information processing device 500 according to the fourth example embodiment of the present disclosure will be described in detail with reference to the drawings.

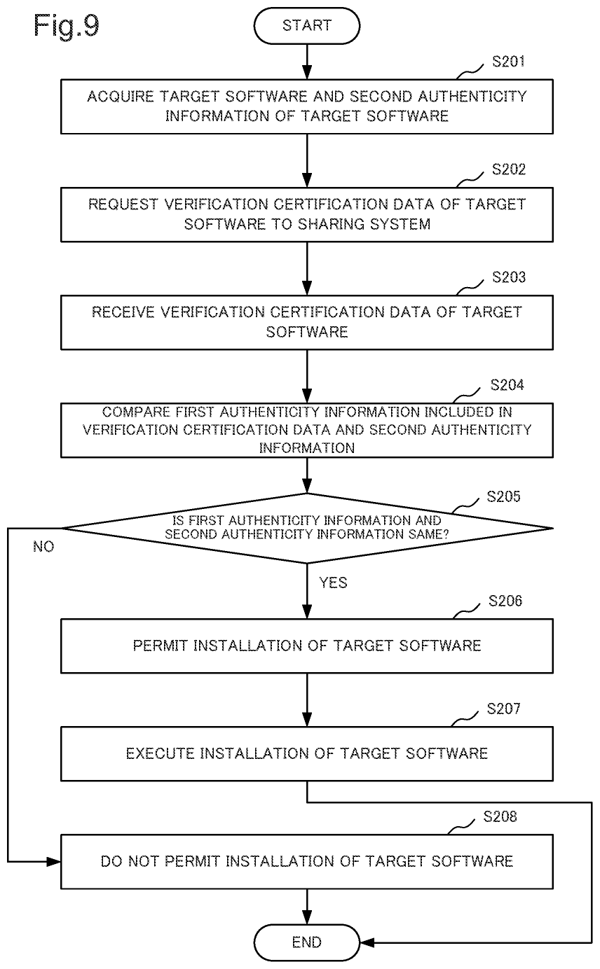

FIG. 9 is a flowchart illustrating an example of an operation of an information processing device according to the fourth example embodiment of the present disclosure.

In the example illustrated in FIG. 9, the software acquisition unit 510 acquires the target software and the second authenticity information of the target software via, for example, a communication network or a storage medium (step S201). The operation in step S201 may be performed, for example, in accordance with an instruction from the user of the information processing device 500. The software acquisition unit 510 sends the second authenticity information to the comparison unit 430 via the authenticity information acquisition unit 410. Then, the operations in and after step S202 are started by, for example, the user of the information processing device 500 performing an operation for instructing the information processing device 500 to install the target software as a trigger.

The certification reception unit 420 requests the sharing system 100 (specifically, the notification unit 140 of the sharing system 100) for the verification certification data of the target software via the certification acquisition unit 530 (step S202). The notification unit 140 of the sharing system 100 reads the requested verification certification data from the information storage unit 150, and sends the read verification certification data to the information processing device 500. The certification reception unit 420 receives the verification certification data of the target software from the notification unit 140 of the sharing system 100 via the certification acquisition unit 530 (step S203).

The comparison unit 430 compares the first authenticity information included in the verification certification data with the second authenticity information (step S204). In a case where the first authenticity information and the second authenticity information are the same (YES in step S205), the control unit 440 permits the installation of the target software (step S206). In other words, the control unit 440 performs control such that the target software is installed. The execution unit 520 executes installation of the target software (step S207). Then, the information processing device 500 ends the operation illustrated in FIG. 9.

In a case where the first authenticity information and the second authenticity information are not the same (NO in step S205), the control unit 440 does not permit the installation of the target software (step S208). In other words, the control unit 440 performs control such that the target software is not installed. Then, the information processing device 500 ends the operation illustrated in FIG. 9.

### <Effects>

The present example embodiment described above has the same effect as the effect of the first example embodiment. The reason is the same as the reason why the effect of the first example embodiment occurs.

### Other Example Embodiments

Each of the sharing system, the information processing device, and the installation control device according to the example embodiment of the present disclosure can be achieved by a computer including a memory in which a program read from a storage medium is loaded and a processor that executes the program. Each of the sharing system, the information processing device, and the installation control device according to the example embodiment of the present disclosure can also be achieved by dedicated hardware. Each of the sharing system, the information processing device, and the installation control device according to the example embodiment of the present disclosure can also be achieved by a combination of the above-described computer and dedicated hardware.

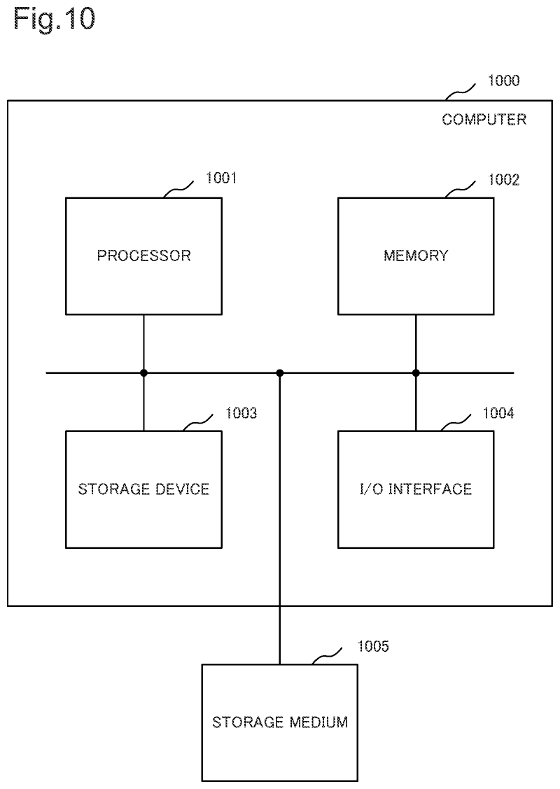

FIG. 10 is a diagram illustrating an example of a hardware configuration of a computer 1000 that can implement a sharing system, an information processing device, and an installation control device according to an example embodiment of the present disclosure. In the example of FIG. 10, the computer 1000 includes a processor 1001, a memory 1002, a storage device 1003, and an input/output (I/O) interface 1004. The computer 1000 can access a storage medium 1005. The memory 1002 and the storage device 1003 are, for example, storage devices such as a random access memory (RAM) and a hard disk. The storage medium 1005 is, for example, a storage device such as a RAM or a hard disk, a read only memory (ROM), or a portable storage medium. The storage device 1003 may be the storage medium 1005. The processor 1001 can read and write data and programs from and in the memory 1002 and the storage device 1003. The processor 1001 can access, for example, other devices via the I/O interface 1004. The processor 1001 may access the storage medium 1005. The storage medium 1005 stores any of a program for operating the computer 1000 as the sharing system according to the example embodiment of the present disclosure, a program for operating the computer as the information processing device according to the example embodiment of the present disclosure, and a program for operating the computer as the installation control device according to the example embodiment of the present disclosure.

The processor 1001 loads the program stored in the storage medium 1005 into the memory 1002. Then, when the processor 1001 executes the program loaded in the memory 1002, the computer 1000 operates as any of the sharing system, the information processing device, and the installation control device according to the example embodiment of the present disclosure.

The software reception unit 110, the certification reception unit 130, the software provision unit 120, and the notification unit 140 can be implemented by, for example, the processor 1001 that executes a program loaded in the memory 1002. The authenticity information acquisition unit 410, the certification reception unit 420, the comparison unit 430, the control unit 440, the software acquisition unit 510, the execution unit 520, and the certification acquisition unit 530 can be implemented by, for example, the processor 1001 that executes a program loaded in the memory 1002. The information storage unit 150 can be achieved by the memory 1002 included in the computer 1000 or the storage device 1003 such as a hard disk device. Some or all of the software reception unit 110, the certification reception unit 130, the software provision unit 120, the notification unit 140, and the information storage unit 150 can be implemented by a dedicated circuit that implements the functions of the units. A part or all of the authenticity information acquisition unit 410, the certification reception unit 420, the comparison unit 430, the control unit 440, the software acquisition unit 510, the execution unit 520, and the certification acquisition unit 530 can be implemented by a dedicated circuit that enables the functions of the units.

Some or all of the above example embodiments may be described as the following Supplementary Notes, but are not limited to the following.

### (Supplementary Note 1)

An installation control device including:
a certification reception unit that receives verification certification data including first authenticity information of target software and indicating that safety of the target software has been verified;
a comparison unit that compares the first authenticity information included in the verification certification data with second authenticity information of the target software; and
a control unit that performs control in such a way that the target software is installed when the first authenticity information is same as the second authenticity information.

### (Supplementary Note 2)

The installation control device according to Supplementary Note 1, wherein
the certification reception unit receives the verification certification data in response to receiving an instruction to install the target software.

### (Supplementary Note 3)

The installation control device according to Supplementary Note 1 or 2, wherein
the control unit performs control in such a way that installation of the target software is not executed when the verification certification data is not obtained.

### (Supplementary Note 4)

The installation control device according to any one of Supplementary Notes 1 to 3, wherein
the control unit performs control in such a way that installation of the target software is not executed when the first authenticity information and the second authenticity information do not match.

### (Supplementary Note 5)

The installation control device according to any one of Supplementary Notes 1 to 4, including
a software acquisition unit that acquires the verification certification data, the target software, and the second authenticity information, wherein
the certification reception unit receives the verification certification data from a sharing system that holds the verification certification data.

### (Supplementary Note 6)

An information processing device including the installation control device according to any one of Supplementary Notes 1 to 5, including
an execution unit that executes installation of the target software according to control by the control unit.

### (Supplementary Note 7)

A sharing system including:
a certification reception unit that receives verification certification data including first authenticity information of target software and indicating that safety of the target software has been verified; and
a notification unit that notifies an installation control device of the verification certification data, the installation control device being configured to: receive the verification certification data; compare the first authenticity information included in the verification certification data with second authenticity information of the target software; and perform control in such a way that the target software is installed when the first authenticity information and the second authenticity information are same.

### (Supplementary Note 8)

The sharing system according to Supplementary Note 7, wherein
the notification unit notifies the verification certification data in response to receiving a request for the verification certification data from the installation control device.

### (Supplementary Note 9)

The sharing system according to Supplementary Note 7 or 8, including:
a software reception unit that receives the target software and the first authenticity information; and
a software provision unit that provides the target software and the first authenticity information to a verification device that verifies safety of the target software, wherein
the certification reception unit receives the verification certification data from the verification device.

### (Supplementary Note 10)

The sharing system according to Supplementary Note 9, including
an information storage unit, wherein
the software reception unit stores the received target software and the received first authenticity information in the information storage unit,
the software provision unit provides the target software and the first authenticity information read from the information storage unit,
the certification reception unit stores the received verification certification data in the information storage unit, and
the notification unit notifies the verification certification data read from the information storage unit.

### (Supplementary Note 11)

The sharing system according to any one of Supplementary Notes 7 to 10, wherein
the installation control device executes installation of the target software when determining that installation of the target software is permitted.

### (Supplementary Note 12)

An installation control method including:
receiving verification certification data including first authenticity information of target software and indicating that safety of the target software has been verified;
comparing the first authenticity information included in the verification certification data with second authenticity information of the target software; and
performing control in such a way that the target software is installed when the first authenticity information and the second authenticity information are same.

### (Supplementary Note 13)

The installation control method according to Supplementary Note 12, further including
receiving the verification certification data in response to receiving an instruction to install the target software.

### (Supplementary Note 14)

The installation control method according to Supplementary Note 12 or 13, further including
performing control in such a way that installation of the target software is not executed when the verification certification data is not obtained.

### (Supplementary Note 15)

The installation control method according to any one of Supplementary Notes 12 to 14, further including
performing control in such a way that installation of the target software is not executed when the first authenticity information and the second authenticity information do not match.

### (Supplementary Note 16)

The installation control method according to any one of Supplementary Notes 12 to 15, further including:
acquiring the verification certification data, the target software, and the second authenticity information; and
receiving the verification certification data from a sharing system that holds the verification certification data.

### (Supplementary Note 17)

The installation control method according to any one of Supplementary Notes 12 to 16, further including
executing installation of the target software according to the control.

### (Supplementary Note 18)

A sharing method including:
receiving verification certification data including first authenticity information of target software and indicating that safety of the target software has been verified; and
notifying an installation control device of the verification certification data, the installation control device being configured to: receive for notifying an installation control device of the verification certification data, the installation control device being configured to: receive the verification certification data; compare the first authenticity information included in the verification certification data with second authenticity information of the target software, and perform control in such a way that the target software is installed when the first authenticity information and the second authenticity information are same.

### (Supplementary Note 19)

The sharing method according to Supplementary Note 18, further including
notifying the verification certification data in response to receiving a request for the verification certification data from the installation control device.

### (Supplementary Note 20)

The sharing method according to Supplementary Note 18 or 19, further including:
receiving the target software and the first authenticity information;
providing the target software and the first authenticity information to a verification device that verifies safety of the target software; and
receiving the verification certification data from the verification device.

### (Supplementary Note 21)

The sharing method according to Supplementary Note 20, further including:
storing the received target software and the received first authenticity information in an information storage unit;
providing the target software and the first authenticity information read from the information storage unit;
storing the received verification certification data in the information storage unit; and
notifying the verification certification data read from the information storage unit.

### (Supplementary Note 22)

The sharing method according to any one of Supplementary Notes 18 to 21, wherein
the installation control device executes installation of the target software when determining that installation of the target software is permitted.

### (Supplementary Note 23)

A storage medium having stored therein a program for causing a computer to execute:
certification reception processing of receiving verification certification data including first authenticity information of target software and indicating that safety of the target software has been verified;
comparison processing of comparing the first authenticity information included in the verification certification data with second authenticity information of the target software; and
control processing of performing control in such a way that the target software is installed when the first authenticity information and the second authenticity information are same.

### (Supplementary Note 24)

The storage medium according to Supplementary Note 23, wherein
the certification reception processing receives the verification certification data in response to receiving an instruction to install the target software.

### (Supplementary Note 25)

The storage medium according to Supplementary Note 23 or 24, wherein
the control processing performs control in such a way that installation of the target software is not executed when the verification certification data is not obtained.

### (Supplementary Note 26)

The storage medium according to any one of Supplementary Notes 23 to 25, wherein
the control processing performs control in such a way that the target software is not executed when the first authenticity information and the second authenticity information do not match.

### (Supplementary Note 27)

The storage medium according to any one of Supplementary Notes 23 to 26, the program further causing the computer to execute
software acquisition processing of acquiring the verification certification data, the target software, and the second authenticity information, wherein
the certification reception processing receives the verification certification data from a sharing system that holds the verification certification data.

### (Supplementary Note 28)

The storage medium according to any one of Supplementary Notes 23 to 27, the program further causing a computer to execute:
execution processing of executing installation of the target software according to control by the control process.

### (Supplementary Note 29)

A storage medium having stored therein a program for causing a computer to execute:
certification reception processing of receiving verification certification data including first authenticity information of target software and indicating that safety of the target software has been verified; and
notification processing of notifying an installation control device of the verification certification data, the installation control device being configured to: receive the verification certification data, compare the first authenticity information included in the verification certification data with second authenticity information of the target software; and perform control in such a way that the target software is installed when the first authenticity information and the second authenticity information are same.

### (Supplementary Note 30)

The storage medium according to Supplementary Note 29, wherein
the notification processing notify the verification certification data in response to receiving a request for the verification certification data from the installation control device.

### (Supplementary Note 31)

The storage medium according to Supplementary Note 29 or 30,
the program further causing a computer to execute:
software reception processing of receiving the target software and the first authenticity information; and
software provision processing of providing the target software and the first authenticity information to a verification device that verifies safety of the target software, wherein
the certification reception processing receive the verification certification data from the verification device.

### (Supplementary Note 32)

The storage medium according to Supplementary Note 31, wherein
the software reception processing stores the received target software and the received first authenticity information in an information storage unit,
the software provision processing provides the target software and the first authenticity information read from the information storage unit,
the certification reception processing stores the received verification certification data in the information storage unit, and
the notification processing notifies the verification certification data read from the information storage unit.

### (Supplementary Note 33)

The storage medium according to any one of Supplementary Notes 29 to 32, wherein
the installation control device executes installation of the target software when determining that installation of the target software is permitted.

Although the present disclosure has been particularly shown and described with reference to the present example embodiment, the present disclosure is not limited to the above example embodiment. It will be understood by those of ordinary skill in the art that various changes in form and details may be made therein without departing from the spirit and scope of the present disclosure as defined by the claims.

### REFERENCE SIGNS LIST

10 sharing system
40 installation control device
100 sharing system
110 software reception unit
120 software provision unit
130 certification reception unit
140 notification unit
150 information storage unit
200 software provision device
300 verification device
320 certification acquisition unit
400 installation control device
410 authenticity information acquisition unit
420 certification reception unit
430 comparison unit
440 control unit
500 information processing device
510 software acquisition unit
520 execution unit
530 certification acquisition unit
1000 computer
1001 processor
1002 memory
1003 storage device
1004 I/O interface
1005 storage medium

What is claimed is:

1. An installation control device comprising:
at least one memory storing a set of instructions; and
at least one processor configured to execute the set of instructions to:
receive verification certification data including first authenticity information of target software and indicating that safety of the target software has been verified;
compare the first authenticity information included in the verification certification data with second authenticity information of the target software; and
perform control in such a way that the target software is installed when the first authenticity information is same as the second authenticity information.

2. The installation control device according to claim 1, wherein
the at least one processor is further configured to execute the instructions to receive the verification certification data in response to receiving an instruction to install the target software.

3. The installation control device according to claim 1, wherein
the at least one processor is further configured to execute the instructions to perform control in such a way that installation of the target software is not executed when the verification certification data is not obtained.

4. The installation control device according to claim 1, wherein
the at least one processor is further configured to execute the instructions to perform control in such a way that installation of the target software is not executed when the first authenticity information and the second authenticity information do not match.

5. The installation control device according to claim 1, wherein
the at least one processor is further configured to execute the instructions to:
acquire the verification certification data, the target software, and the second authenticity information; and
receive the verification certification data from a sharing system that holds the verification certification data.

6. An information processing device including the installation control device according to claim 1, wherein
the at least one processor is further configured to execute the instructions to execute installation of the target software according to control by the installation control device.

7. A system including a sharing system and the installation control device according to claim 1, the sharing system comprising:
at least one second memory storing a set of instructions; and
at least one second processor configured to execute the set of instructions to:
receive verification certification data including first authenticity information of target software and indicating that safety of the target software has been verified; and
notify the installation control device of the verification certification data.

8. The system according to claim 7, wherein
the at least one second processor is further configured to execute the instructions to notify the verification certification data in response to receiving a request for the verification certification data from the installation control device.

9. The system according to claim 7, comprising:
the at least one second processor is further configured to execute the instructions to:
receive the target software and the first authenticity information;
provide the target software and the first authenticity information to a verification device that verifies safety of the target software; and
receive the verification certification data from the verification device.

10. The system according to claim 9, comprising information storage, wherein
the at least one second processor is further configured to execute the instructions to:
store the received target software and the received first authenticity information in the information storage;
provide the target software and the first authenticity information read from the information storage;
store the received verification certification data in the information storage; and
notify the verification certification data read from the information storage.

11. The system according to claim 7,
the installation control device executes installation of the target software when determining that installation of the target software is permitted.

12. An installation control method comprising:
receiving verification certification data including first authenticity information of target software and indicating that safety of the target software has been verified;
comparing the first authenticity information included in the verification certification data with second authenticity information of the target software; and
performing control in such a way that the target software is installed when the first authenticity information and the second authenticity information are same.

13. The installation control method according to claim 12, further comprising receiving the verification certification data in response to receiving an instruction to install the target software.

14. The installation control method according to claim 12, further comprising
performing control in such a way that installation of the target software is not executed when the verification certification data is not obtained.

15. The installation control method according to claim 12, further comprising
performing control in such a way that installation of the target software is not executed when the first authenticity information and the second authenticity information do not match.

16. The installation control method according to claim 12, further comprising:
acquiring the verification certification data, the target software, and the second authenticity information; and
receiving the verification certification data from a sharing system that holds the verification certification data.

17. The installation control method according to claim 12, further comprising
executing installation of the target software according to the control.

18. A method including a sharing method and the installation control method according to claim 12, the sharing method comprising:
receiving verification certification data including first authenticity information of target software and indicating that safety of the target software has been verified; and
notifying an installation control device of the verification certification data, the installation control device performing the installation control method.

19. The method according to claim 18, sharing method further comprising
notifying the verification certification data in response to receiving a request for the verification certification data from the installation control device.

20-22. (canceled)

23. A non-transitory computer readable storage medium having stored therein a program for causing a computer to execute:
verification reception processing of receiving verification certification data including first authenticity information of target software and indicating that safety of the target software has been verified;
comparison processing of comparing the first authenticity information included in the verification certification data with second authenticity information of the target software; and
control processing of performing control in such a way that the target software is installed when the first authenticity information and the second authenticity information are same.

24-33. (canceled)
